(19) United States
(12) Patent Application Publication
(10) Pub. No.: US 2025/0191129 A1
(43) Pub. Date: Jun. 12, 2025

(54) IMAGE GENERATION SYSTEM, IMAGE GENERATION METHOD, AND PROGRAM

(71) Applicant: Panasonic Intellectual Property Management Co., Ltd., Osaka (JP)

(72) Inventors: Ryosuke GOTO, Osaka (JP); Taichi SATO, Kyoto (JP); Satoshi HIROTSUNE, Hyogo (JP)

(21) Appl. No.: 18/846,575

(22) PCT Filed: Mar. 23, 2023
(86) PCT No.: PCT/JP2023/011538

§ 371 Date: Sep. 12, 2024

(30) Foreign Application Priority Data
Mar. 29, 2022 (JP) 2022-054529

(51) Int. Cl. G06T 5/50; G06T 3/40; G06T 7/00; G06T 7/11

(52) U.S. Cl. CPC G06T 5/50; G06T 3/40; G06T 7/0008; G06T 7/11; G06T 2207/20081; G06T 2207/20221; G06T 2207/30136

(57) ABSTRACT

An image generation system includes a first image acquirer, a second image acquirer, and an image processor. The image processor performs image transformation processing and superposition processing. The image transformation processing includes generating, based on a first image, a transformed image by subjecting a predetermined extracted part of a first object to image processing. The image transformation processing includes: processing of dividing the extracted part into a plurality of segments; and processing of changing at least one parameter selected from the group consisting of a grayscale, a location, a size, and an orientation of at least one segment belonging to the plurality of segments.

### TECHNICAL FIELD

The present disclosure generally relates to an image generation system, an image generation method, and a program, and more particularly relates to an image generation system, an image generation method, and a program, all of which are used to generate an image by superposing a plurality of images one on top of another.

### BACKGROUND ART

Patent Literature 1 discloses an image display device (image generation system), which includes an image designating means, an image processing means, an image synthesizing means, and an image display means. The image designating means designates an original image as a processing target. The image processing means processes the original image to generate a processed image. The image synthesizing means generates an overall image by replacing a partial area of the image with a corresponding partial area of the processed image. The image display means displays either all of the overall image or a part, including a boundary, of the overall image.

As can be seen, the image display device of Patent Literature 1 may generate a new image based on the original image. However, it is difficult for the image display device to generate an image suitable for machine learning.

### CITATION LIST

### Patent Literature

Patent Literature 1: JP 2006-3603 A

### Summary of Invention

An object of the present disclosure is to provide an image generation system, an image generation method, and a program, all of which enable generating an image suitable for machine learning.

An image generation system according to an aspect of the present disclosure includes a first image acquirer, a second image acquirer, and an image processor. The first image acquirer acquires a first image by shooting a first object. The second image acquirer acquires a second image by shooting a second object. The image processor performs image transformation processing and superposition processing. The image transformation processing includes generating, based on the first image, a transformed image by subjecting an extracted part that forms a predetermined part of the first object to image processing. The superposition processing includes generating a superposed image by superposing the transformed image on the second image. The image transformation processing includes: processing of dividing the extracted part into a plurality of segments; and processing of changing at least one parameter selected from the group consisting of a grayscale, a location, a size, and an orientation of at least one segment belonging to the plurality of segments.

An image generation method according to another aspect of the present disclosure includes first image acquisition processing, second image acquisition processing, image transformation processing, and superposition processing. The first image acquisition processing includes acquiring a first image by shooting a first object. The second image acquisition processing includes acquiring a second image by shooting a second object. The image transformation processing includes generating, based on the first image, a transformed image by subjecting an extracted part that forms a predetermined part of the first object to image processing. The superposition processing includes generating a superposed image by superposing the transformed image on the second image. The image transformation processing includes: processing of dividing the extracted part into a plurality of segments; and processing of changing at least one parameter selected from the group consisting of a grayscale, a location, a size, and an orientation of at least one segment belonging to the plurality of segments.

A program according to still another aspect of the present disclosure is designed to cause one or more processors of a computer system to perform the image generation method described above.

### BRIEF DESCRIPTION OF DRAWINGS

FIG. 1 is a block diagram of an image generation system according to an exemplary embodiment;

FIG. 2 is a schematic representation illustrating an exemplary first image for use in the image generation system;

FIG. 3 is a schematic representation illustrating an exemplary second image for use in the image generation system;

FIGS. 4A-4D are schematic representations illustrating exemplary images generated by the image generation system;

FIG. 5 is a schematic representation illustrating an exemplary superposed image generated by the image generation system;

FIG. 6 is a flowchart showing an exemplary procedure of processing performed by the image generation system; and

FIGS. 7A-7E are schematic representations illustrating exemplary images generated by an image generation system according to a first variation.

### DESCRIPTION OF EMBODIMENTS

### Embodiment

An image generation system 5 according to an exemplary embodiment will now be described with reference to the accompanying drawings. Note that the exemplary embodiment to be described below is only an exemplary one of various embodiments of the present disclosure and should not be construed as limiting. Rather, the exemplary embodiment may be readily modified in various manners depending on a design choice or any other factor without departing from the scope of the present disclosure. The drawings to be referred to in the following description of embodiments are all schematic representations. Thus, the ratio of the dimensions (including thicknesses) of respective constituent elements illustrated on the drawings does not always reflect their actual dimensional ratio.

### Overview

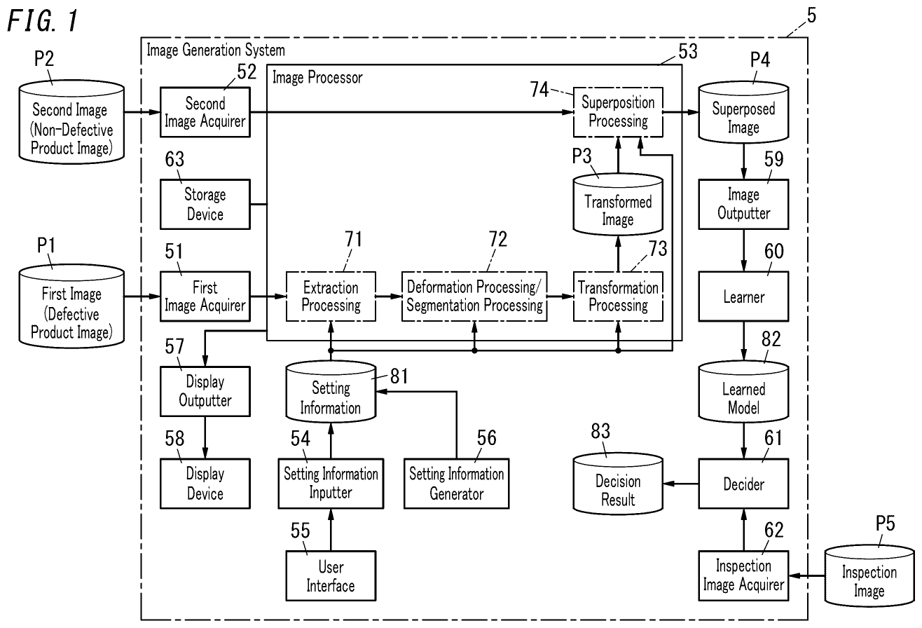

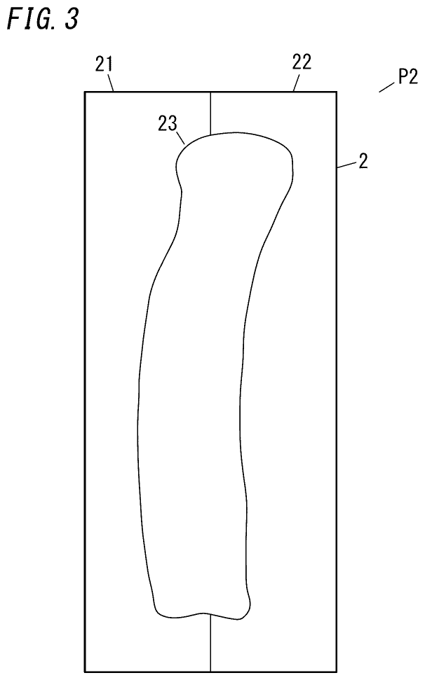

As shown in FIG. 1, an image generation system 5 according to this embodiment generates a superposed image P4 based on a first image P1 and a second image P2. The superposed image P4 is used as learning data for generating a learned model 82 about an object (e.g., an object comparable to the second object 2 (refer to FIG. 3)). That is to say, the superposed image P4 is learning data for use to generate a model by machine learning.

As used herein, the “model” refers to a program designed to recognize, in response to entry of input information about an object to be recognized (object), the condition of the object to be recognized and output a result of recognition. Also, as used herein, the “learned model” refers to a model about which machine learning using learning data is completed. Furthermore, the “learning data (set)” as used herein refers to a data set including, in combination, input information (image) to be entered for a model and a label attached to the input information, i.e., so-called “training data.” That is to say, in this embodiment, the learned model 82 is a model about which machine learning has been done by supervised learning.

The learned model 82 as used herein may include, for example, either a model that uses a neural network or a model generated by deep learning using a multilayer neural network. Examples of the neural networks may include a convolutional neural network (CNN) and a Bayesian neural network (BNN). The learned model 82 may be implemented by, for example, installing a learned neural network into an integrated circuit such as an application specific integrated circuit (ASIC) or a field-programmable gate array (FPGA). However, the learned model 82 does not have to be a model generated by deep learning. Alternatively, the learned model 82 may also be a model generated by a support vector machine or a decision tree, for example.

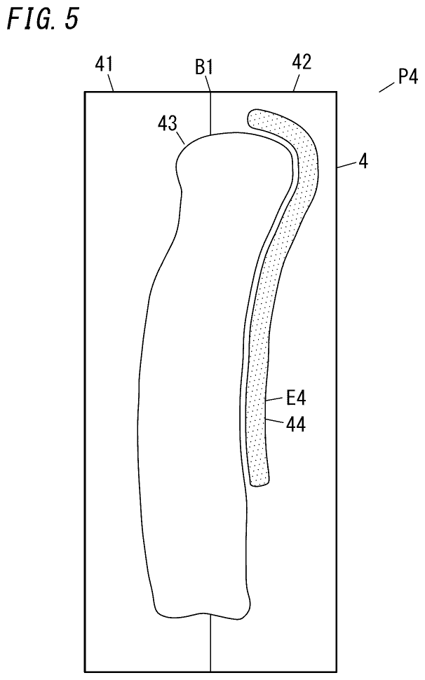

In this embodiment, the object to be recognized may be, for example, a welded product. FIG. 5 is an exemplary superposed image P4 (learning data) in which the object 4 is shot. The object 4, as well as the object to be recognized, is a welded product. The object 4 includes a first base metal 41, a second base metal 42, and a bead 43.

The bead 43 is formed, when two or more welding base materials (e.g., the first base metal 41 and the second base metal 42 in this example) are welded together via a metallic welding material, in a boundary B1 (welding spot) between the first base metal 41 and the second base metal 42. The dimensions and shape of the bead 43 depend mainly on the welding material. The object 4 further includes a defective part 44. In the following description, a spot with the defective part 44 will be hereinafter referred to as a “defect produced spot E4.” In FIG. 5, the defect produced spot E4 is included in the second base metal 42.

Thus, when an image representing the object to be recognized (hereinafter simply referred to as an “object”) is entered as an inspection image P5, the learned model 82 recognizes the condition of the object and outputs a result of recognition. Specifically, the learned model 82 outputs, as the result of recognition, information indicating whether the object is a defective product or a non-defective (i.e., good) product and information about the type of the defect if the object is a defective product. That is to say, the learned model 82 is used to determine whether the object is a good product or not. In other words, the learned model 82 is used to conduct a weld appearance test to determine whether welding has been done properly.

Decision about whether the object is good or defective may be made depending on, for example, whether the length of the bead, the height of the bead, the angle of elevation of the bead, the throat depth of the bead, the excess metal of the bead, and the misalignment of the welding spot of the bead (including the degree of shift of the beginning of the bead) fall within their respective tolerance ranges. For example, if at least one of these parameters enumerated above fails to fall within its tolerance range, then the object is determined to be a defective product. Alternatively, decision about whether the object is good or defective may also be made depending on, for example, whether the object has any undercut and whether the bead has any defective portion (e.g., whether the bead has any pit, whether the bead has any sputter, and whether the bead has any projection). For example, if at least one of these imperfections enumerated above is spotted, then the object is determined to be a defective product.

To make machine learning about a model, a great many image data items about the objects to be recognized, including defective products, need to be collected as learning data. However, if the objects to be recognized turn out to be defective at a low frequency of occurrence on a production line of the objects, then learning data required to generate a learned model 82 with high recognizability tends to be short. Thus, to overcome this problem, machine learning about a model may be made with the number of learning data items increased by performing data augmentation processing about learning data (i.e., the first image P1 and the second image P2) acquired by actually shooting the object. As used herein, the data augmentation processing refers to the processing of increasing the number of learning data items by subjecting the learning data to various types of processing such as synthesis, translation, scaling up or down (expansion or contraction), rotation, flipping, and addition of noise, for example. According to this embodiment, at least one superposed image P4 (which is supposed to be a great many superposed images P4 by the present inventors) is generated by performing the data augmentation processing and used as the learning data. In addition, according to this embodiment, the superposed images P4 are generated by performing, on a plurality of original images (i.e., a plurality of learning data items) that have not been subjected to image processing yet by the image generation system 5, the processing of superposing (i.e., synthesizing) these original images together.

Note that the plurality of original images (i.e., the first image P1 and the second image P2) for use to generate the superposed image P4 do not have to be used as learning data for generating the learned model 82. That is to say, the learning data for use to generate the learned model 82 may either consist of only the plurality of superposed images P4 or include the first image P1, the second image P2, and other images not generated by the image generation system 5, in addition to the at least one superposed image P4. That is to say, the learning data for use to generate the learned model 82 may or may not include the original images that have not been subjected to the image processing yet by the image generation system 5. Also, the learning data for use to generate the learned model 82 may include images generated by a system other than the image generation system 5.

As shown in FIG. 1, an image generation system 5 according to this embodiment includes a first image acquirer 51, a second image acquirer 52, and an image processor 53. The first image acquirer 51 acquires a first image P1 by shooting a first object 1. The second image acquirer 52 acquires a second image P2 by shooting a second object 2. The image processor 53 performs image transformation processing (processing 72, 73) and superposition processing 74. The image transformation processing includes generating, based on the first image P1, a transformed image P3 by subjecting a predetermined extracted part 140 of the first object 1 to image processing. The superposition processing 74 includes generating a superposed image P4 by superposing the transformed image P3 on the second image P2. The image transformation processing includes: the processing of dividing the extracted part 140 into a plurality of segments 141; and the processing of changing at least one parameter selected from the group consisting of a grayscale, a location, a size, and an orientation of at least one segment 141 belonging to the plurality of segments 141.

This embodiment enables generating an image (superposed image P4) suitable for machine learning. In particular, before a superposed image P4 is generated by superposing the transformed image P3 on the second image P2, the processing of dividing the extracted part 140 into a plurality of segments 141 is performed, and the processing of changing at least one parameter selected from the group consisting of a grayscale, a location, a size, and an orientation of at least one segment 141 (hereinafter referred to as “transformation processing”) is further performed. That is to say, the transformation processing is performed on a segment 141 basis. This makes it easier to determine the parameter (setting information 81) as a decisive factor of the transformation processing and generate a superposed image P4 desired for the user, for example, compared to a situation where the extracted part 140 is not divided. This contributes to improving the accuracy of machine learning using the superposed image P4.

The functions of the image generation system 5 may also be implemented as an image generation method. An image generation method according to this embodiment includes first image acquisition processing, second image acquisition processing, image transformation processing (processing 72, 73), and superposition processing 74. The first image acquisition processing includes acquiring a first image P1 by shooting a first object 1. The second image acquisition processing includes acquiring a second image P2 by shooting a second object 2. The image transformation processing includes generating, based on the first image P1, a transformed image P3 by subjecting a predetermined extracted part 140 of the first object 1 to image processing. The superposition processing 74 includes generating a superposed image P4 by superposing the transformed image P3 on the second image P2. The image transformation processing includes: the processing of dividing the extracted part 140 into a plurality of segments 141; and the processing of changing at least one parameter selected from the group consisting of a grayscale, a location, a size, and an orientation of at least one segment 141 belonging to the plurality of segments 141.

The image generation method preferably further includes setting information generation processing. The setting information generation processing includes generating setting information 81 (refer to FIG. 1) about the processing of generating the superposed image P4 based on the first image P1 and the second image P2.

Also, the image generation method is used on a computer system (image generation system 5). That is to say, the image generation method may also be implemented as a program. A program according to this embodiment is designed to cause one or more processors of a computer system to perform the image generation method according to this embodiment. The program may be stored on a computer-readable non-transitory storage medium.

### Details

Next, an image generation system 5 according to this embodiment will be described in further detail.

### (1) Overall Configuration

The image generation system 5 shown in FIG. 1 includes a computer system including one or more processors and a memory. At least some functions of the image generation system 5 are performed by making the processor of the computer system execute a program stored in the memory of the computer system. The program may be stored in the memory. Alternatively, the program may also be downloaded via a telecommunications line such as the Internet or distributed after having been stored in a non-transitory storage medium such as a memory card.

The image generation system 5 may be installed either inside a factory as a place where welding is performed. Alternatively, at least some constituent elements of the image generation system 5 may be installed outside the factory (e.g., at a business facility located at a different place from the factory).

As described above, the image generation system 5 has the function of increasing the number of the learning data items by performing data augmentation processing on the original image (learning data) as described above. In the following description, a person who uses the image generation system 5 will be hereinafter simply referred to as a “user.” The user may be, for example, an operator who monitors a manufacturing process such as a welding process step in a factory or a chief administrator.

In this embodiment, the learned model 82 is generated by machine learning as described above. The learned model 82 may be implemented as any type of artificial intelligence or system.

In this case, the algorithm of machine learning may be, for example, a neural network. However, the machine learning algorithm does not have to be the neural network but may also be, for example, extreme gradient boosting (XGB) regression, random forest, decision tree, logistic regression, support vector machine (SVM), naive Bayes classifier, or k-nearest neighbors method. Alternatively, the machine learning algorithm may also be a Gaussian mixture model (GMM) or k-means clustering, for example.

Furthermore, the learned model 82 does not have to be generated by the machine learning for classifying inspection images into two classes consisting of a non-defective product and a defective product. Alternatively, the learned model 82 may also be generated by machine learning for classifying the inspection images into multiple classes including a non-defective product, a pit, a sputter, a projection, a burn-through, and an undercut. As used herein, the pit, sputter, projection, burn-through, and undercut are respective types of defects. Still alternatively, the learned model 82 may also be generated by machine learning involving object detection and segmentation for locating a defective part on an inspection image and detecting the type of the defect.

In this embodiment, the learning method may be supervised learning, for example. However, the learning method does not have to be supervised learning but may be unsupervised learning or reinforcement learning as well.

In the example shown in FIG. 1, the image generation system 5 includes a storage device 63 for storing the learning data. The storage device 63 includes a programmable nonvolatile memory such as an electrically erasable programmable read-only memory (EEPROM). Alternatively, the storage device 63 may also be a memory built in the image generation system 5. Still alternatively, the storage device 63 may also be provided outside of the image generation system 5.

As shown in FIG. 1, the image generation system 5 includes the first image acquirer 51, the second image acquirer 52, the image processor 53, a setting information inputter 54, a user interface 55, a setting information generator 56, a display outputter 57, and a display device 58. The image generation system 5 further includes an image outputter 59, a learner 60, a decider 61, an inspection image acquirer 62, and a storage device 63.

Among these constituent elements, at least the user interface 55, the display device 58, and the storage device 63 each have a substantive configuration. On the other hand, the first image acquirer 51, the second image acquirer 52, the image processor 53, the setting information inputter 54, the setting information generator 56, the display outputter 57, the image outputter 59, the learner 60, the decider 61, and the inspection image acquirer 62 just represent respective functions to be performed by one or more processors of the image generation system 5 and do not necessarily have a substantive configuration.

### (2) First Image Acquirer

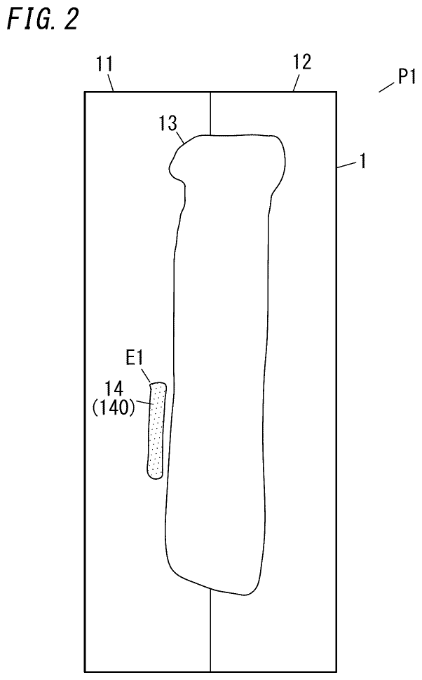

The first image acquirer 51 acquires a first image P1. As shown in FIG. 2, the first image P1 is an image generated by shooting a first object 1. The first image acquirer 51 may acquire the first image P1 from an external device provided outside of the image generation system 5 or the storage device 63 of the image generation system 5, whichever is appropriate. In the example shown in FIG. 1, the first image acquirer 51 acquires the first image P1 from an external device provided outside of the image generation system 5. For example, the first image acquirer 51 may acquire the first image P1 from a computer server.

Also, an image capture device for generating the first image P1 by shooting the first object 1 may be provided for the image generation system 5 or provided outside of the image generation system 5, whichever is appropriate.

The first object 1 is a defective product. As used herein, the “defective product” refers to an article in which a defect has been produced. The user of the image generation system 5 may determine as appropriate what condition of the article should be regarded as a condition in which a defect has been produced.

The first image P1 is an image generated by shooting at least a defect produced spot E1 of the first object 1 (i.e., a defective product image). Nevertheless, the range covered by the first image P1 is not limited to the defect produced spot E1 but may include a spot, other than the defect produced spot E1, of the first object 1 as well. In the example shown in FIG. 2, the range covered by the first image P1 is the entire first object 1.

The first object 1 includes a first base metal 11, a second base metal 12, and a bead 13. The first base metal 11, the second base metal 12, and the bead 13 have the same structures as the first base metal 41, the second base metal 42, and the bead 43 of the object 4 described above, and therefore, description thereof will be omitted herein. The first object 1, however, has another defective part 14 in a different shape from the defective part 44 at a different spot from the spot where the object 4 has the defective part 44 (i.e., the defect produced spot E4). More specifically, the defective part 14 is present on the first base metal 11.

### (2) Second Image Acquirer

The second image acquirer 52 acquires a second image P2. As shown in FIG. 3, the second image P2 is an image generated by shooting a second object 2. The second image acquirer 52 may acquire the second image P2 from an external device provided outside of the image generation system 5 or from the storage device 63 of the image generation system 5, whichever is appropriate. In the example shown in FIG. 1, the second image acquirer 52 acquires the second image P2 from an external device provided outside of the image generation system 5. For example, the second image acquirer 52 may acquire the second image P2 from a computer server.

Also, an image capture device for generating the second image P2 by shooting the second object 2 may be provided for the image generation system 5 or provided outside of the image generation system 5, whichever is appropriate.

The second object 2 is a non-defective product. As used herein, the “non-defective product” refers to an article in which no defects have been produced. In the example shown in FIG. 2, the range covered by the second image P2 is the entire second object 2. However, this is only an example and should not be construed as limiting. Alternatively, the range covered by the second image P2 may also be only a part of the second object 2.

The second object 2 includes a first base metal 21, a second base metal 22, and a bead 23. The first base metal 21, the second base metal 22, and the bead 23 have the same structures as the first base metal 41, the second base metal 42, and the bead 43 of the object 4 described above, respectively, and therefore, description thereof will be omitted herein. The second object 2, however, has no parts corresponding to the defective part 44.

### (4) First Image and Second Image

The first image P1 may be, for example, a distance image including coordinate information in a depth direction (i.e., a direction pointing from the image capture device toward the first object 1). The second image P2 may be, for example, a distance image including coordinate information in a depth direction (i.e., a direction pointing from the image capture device toward the second object 2). The coordinate information in the depth direction may be expressed by, for example, grayscales. Specifically, the higher the density of a point of interest in a distance image is, the deeper the point of interest is located. Conversely, the lower the density of a point of interest in a distance image is, the deeper the point of interest may be located.

The image capture device for use to generate the distance image is a distance image sensor such as a line sensor camera. A plurality of objects are sequentially shot by the image capture device one after another, thereby generating a plurality of images. The first image P1 and the second image P2 are selected in accordance with the user's instruction from the plurality of images generated by the image capture device. The image generation system 5 preferably includes an operating unit for accepting his or her instruction about the selection. For example, the user interface 55 may be used as the operating unit.

### (5) Image Processor

The image processor 53 may be implemented as, for example, a digital signal processor (DSP) or a field-programmable gate array (FPGA). The image processor 53 performs extraction processing 71, image transformation processing (processing 72, 73), and superposition processing 74. The image processor 53 performs the extraction processing 71, the image transformation processing (processing 72, 73), and the superposition processing 74 in accordance with setting information 81. As will be described later, the setting information 81 may be entered by the user or automatically generated by the setting information generator 56, whichever is appropriate.

In the following description of embodiments, an image generated by the image transformation processing (processing 72, 73) will be hereinafter referred to as a “transformed image P3.” An image generated as an intermediate product during the image transformation processing (processing 72, 73) will also be hereinafter referred to as a “transformed image P3.” Furthermore, an image generated by the superposition processing 74 will be hereinafter referred to as a “superposed image P4.”

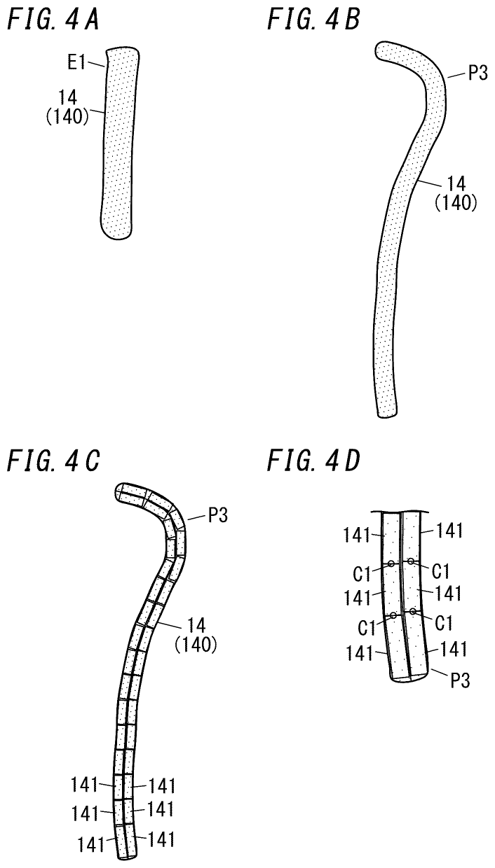

The extracted part 140 is a part of the first object 1. The extraction processing 71 is the processing of extracting the extracted part 140 from the first object 1 shot in the first image P1 (refer to FIG. 2). That is to say, an extracted image representing the extracted part 140 is generated based on the first image P1 as shown in FIG. 4A.

In this embodiment, the extracted part 140 corresponds with the defective part 14. The defective part 14 corresponds with the defect produced spot E1. That is to say, the first image P1 is an image in which the defect produced spot E1 of the first object 1 has been shot. The second image P2 is an image in which the second object 2 as a non-defective product has been shot. The extracted part 140 covers at least a part (e.g., all in this embodiment) of the defect produced spot E1.

The processing 72 includes deformation processing and segmentation processing. Any one of the deformation processing or the segmentation processing may be performed earlier than the other. In the following description of embodiments, the segmentation processing is supposed to be performed after at least part of the deformation processing has been performed first.

The deformation processing is the processing of deforming the extracted part 140 by bending the extracted part 140. More specifically, the deformation processing is the processing of deforming the extracted part 140 according to the shape of the second object 2 shot in the second image P2. In addition, the deformation processing may also include the processing of expanding or compressing the extracted part 140 in a predetermined direction. Furthermore, the deformation processing may further include the processing of flipping (e.g., mirror-reversing) the extracted part 140. A transformed image P3 such as the one shown in FIG. 4B is generated by performing the deformation processing on the extracted image. Then, the superposition processing 74 includes disposing the extracted part 140 according to the shape of the second object 2.

Deforming the extracted part 140 according to the shape of the second object 2 may, for example, either turn a linear extracted part 140 into a curvilinear one or turn a curvilinear extracted part 140 into a linear one, whichever is appropriate. Alternatively, the deformation processing may also turn a curvilinear extracted part 140 into a curvilinear extracted part 140 in a different shape from that of the extracted part 140 that has not been deformed yet. Optionally, the extracted part 140 may also be subjected to any type of deformation other than the ones cited above.

The processing 72 may include the processing of extracting a contour or an edge of at least a part of the second object 2 shot in the second image P2. For example, a part of the second image P2 where the luminance varies more significantly than a threshold value may be extracted as either a contour or an edge. Also, when performing the deformation processing, the image processor 53 may deform the extracted part 140 by bending the extracted part 140 along either the contour or the edge. That is to say, in the image transformation processing, deforming the extracted part 140 according to the shape of the second object 2 shot in the second image P2 may be deforming the extracted part 140 along the contour or edge of at least a part of the second object 2 shot in the second image P2. In that case, the superposition processing 74 includes disposing the extracted part 140 along the contour or edge of the at least part of the second object 2. In FIG. 4B, the extracted part 140 has been deformed along either the contour or edge of an upper right to lower right part of the bead's 43 contour of the second object 2 shown in FIG. 5.

The segmentation processing is the processing of dividing the extracted part 140 into a plurality of segments 141. A transformed image P3 such as the one shown in FIG. 4C is generated by subjecting the extracted image to the deformation processing and then the segmentation processing. As can be seen, the image transformation processing includes the processing of dividing the extracted part 140 into a plurality of segments 141. In FIG. 4C, the boundary between each pair of segments 141 is indicated by a rectangular frame line. FIG. 4D is an enlarged view of a part of FIG. 4C.

The processing 73 includes the processing of changing at least one parameter selected from the group consisting of a grayscale of the extracted part 140, the location of the extracted part 140, the size of the extracted part 140, and an orientation of the extracted part 140. That is to say, the image transformation processing includes the processing of changing at least one parameter selected from the group consisting of a grayscale of the extracted part 140, the location of the extracted part 140, the size of the extracted part 140, and an orientation of the extracted part 140. If the first image P1 is a distance image, the coordinate of the extracted part 140 in the depth direction is caused to change by changing the grayscale thereof. Changing the location, size and orientation thereof causes the location, size, and orientation of the transformed image P3 to change with respect to the second object 2 when the transformed image P3 is superposed on the second image P2 during the superposition processing 74.

The processing 73 allows the grayscale to be changed on a segment 141 basis. Also, if the deformation processing is performed after the segmentation processing, the center of rotation C1 of each of the plurality of segments 141 is arranged to be adjacent to another segment 141 during the deformation processing as shown in FIG. 4D. That is to say, in this case, the deformation processing may change the orientation of a least some segment 141 by rotating at least the segment 141 around the center of rotation C1. Alternatively, some segments 141 may be moved (on an XY plane) relative to other segments 141. In this case, the XY plane intersects at right angles with the rotational axis (i.e., the center of rotation C1). Optionally, the size may be changed from one segment 141 to another.

The superposition processing 74 includes generating a superposed image P4 by superposing the transformed image P3 on the second image P2. That is to say, the superposed image P4 is generated as shown in FIG. 5 by generating the transformed image P3 as shown in FIG. 4C by the image transformation processing and then superposing the transformed image P3 on the second image P2 (refer to FIG. 3).

In this case, the transformed image P3 is an image generated by subjecting the defective part 14 of the first object 1 to image processing. Thus, the object 4 shot in the superposed image P4 includes a defective part 44 generated by subjecting the defective part 14 to image processing. That is to say, the superposed image P4 is an image which presents at least the defect produced spot E4 of the object 4 (i.e., a defective product image).

Also, the superposed image P4 is a three-dimensional image in which the depth is expressed as grayscales. That is to say, the superposed image P4 represents, as grayscales, pieces of coordinate information in the depth direction of the transformed image P3 and the second image P2.

The superposition processing 74 preferably includes interpolation processing of interpolating a boundary between the transformed image P3 and the second image P2 to smoothly connect the transformed image P3 to the second image P2. This allows a more natural superposed image P4 to be generated. The interpolation processing may be performed, for example, as linear interpolation.

### (6) Setting Information

Next, the setting information 81 for use to define the processing to be performed by the image processor 53 will be described. The setting information 81 is information for use in the processing of generating the superposed image P4 based on the first image P1 and the second image P2. More specifically, the setting information 81 includes information about at least one processing selected from the group consisting of the extraction processing 71, the image transformation processing (processing 72, 73), and the superposition processing 74.

The setting information inputter 54 acquires the setting information 81. The setting information inputter 54 acquires the setting information 81 from the user interface 55 which accepts the user's operation of entering the setting information 81. The user interface 55 includes at least one selected from the group consisting of, for example, a mouse, a keyboard, and a touch pad.

The setting information 81 includes one or more pieces of information selected from the following first to sixth pieces of information. A first piece of information which may be included in the setting information 81 is information for use to determine the range of the extracted part 140 in the first image P1. A second piece of information which may be included in the setting information 81 is information for use to determine the number of segments of the extracted part 140 in the image transformation processing. A third piece of information which may be included in the setting information 81 is information for use to enter a change in at least one parameter selected from the group consisting of a grayscale of the extracted part 140, the location of the extracted part 140, the size of the extracted part 140, and an orientation of the extracted part 140 in the image transformation processing. A fourth piece of information which may be included in the setting information 81 is information for use to determine a mixing ratio of the transformed image P3 and the second image P2 in the superposition processing 74. A fifth piece of information which may be included in the setting information 81 is information about at least one parameter selected from the group consisting of the respective grayscales, locations, sizes, and orientations (rotational angles) of a plurality of segments 141. A sixth piece of information which may be included in the setting information 81 is information about an expansion ratio in the processing of expanding or compressing the extracted part 140 in a predetermined direction.

The image processor 53 may define the range selected by the user using the user interface 55 to be the range of the extracted part 140. The image processor 53 may also define, for example, the number of segments entered by the user using the user interface 55 to be the number of segments of the extracted part 140 to generate segments 141 in the number specified by the number of segments. The image processor 53 may change the grayscale, location, size, and orientation of each segment 141 or the entire extracted part 140, for example, in accordance with the information entered by the user using the user interface 55. The image processor 53 may also superpose the transformed image P3 on the second image P2 at the mixing ratio entered by the user using the user interface 55, for example. The mixing ratio may be, for example, the ratio of the respective a values of the transformed image P3 and the second image P2. The image processor 53 superposes the transformed image P3 on the second image P2 by a blending.

The setting information generator 56 generates the setting information 81. The setting information generator 56 may define the range of the extracted part 140 in the first image P1 using, for example, a predetermined learned model for detecting the defective part 14 (extracted part 140) from an image. In addition, the setting information generator 56 determines the number of segments of the extracted part 140 according to the size of the extracted part 140, for example.

Optionally, the setting information 81 generated by the setting information generator 56 may be given randomness. For example, the setting information generator 56 may determine, at random, at least one of the location, size, or orientation of the extracted part 140 (transformed image P3) with respect to the second image P2.

Note that the phrase “at random” as used herein does not necessarily mean that all events occur at an equal probability. The setting information generator 56 may set, by reference to the information about the probability of occurrence of defects in each of a plurality of areas on the second object 2, for example, the parameter for determining the location of the extracted part 140 at random so that the higher the probability of occurrence in an area is, the more likely the area is selected as the location of the extracted part 140.

Optionally, the setting information generator 56 may attach a label to the superposed image P4. The setting information generator 56 may determine the label to be attached to the superposed image P4 according to the label attached to the first image P1, for example. Specifically, if the label attached to the first image P1 is a label “defective product” and the extracted part 140 of the first image P1 corresponds with the defect produced spot E1, then the setting information generator 56 may attach the label “defective product” to the superposed image P4. In that case, the label may include the type of the defect, which may be the same as the type of defect of the first image P1.

### (7) Display Outputter and Display Device

The display outputter 57 outputs information to the display device 58. In response, the display device 58 conducts a display operation in accordance with the information that the display device 58 has received from the display outputter 57.

The display device 58 includes a display. The display may be, for example, a liquid crystal display or an organic electroluminescent (EL) display. The display device 58 may display, for example, the first image P1, the second image P2, the transformed image P3, and the superposed image P4. The display device 58 may be used as an output interface for conducting a display operation about the setting information 81 while the user is entering the setting information 81 into the user interface 55. The user may, for example, define the range of the extracted part 140 by operating the user interface 55 to move the cursor displayed on the display device 58 when the first image P1 is displayed on the display device 58. In addition, the user may also enter the grayscale or orientation of the extracted part 140 or the respective a values of the transformed image P3 and the second image P2 by, for example, moving the cursor to a slider displayed on the display device 58 and performing a drag operation.

In addition, the display outputter 57 also outputs information about the plurality of segments 141 to the display device 58. The display device 58 displays the plurality of segments 141 in accordance with the information about the plurality of segments 141 that the display device 58 has acquired from the display outputter 57. This allows the user to choose his or her desired segment 141 and enter the setting information 81 about the segment 141 thus chosen.

In addition, the display device 58 also displays a decision result 83 provided by the decider 61 (to be described later).

### (8) Types of Defects

In this embodiment, the first object 1 is an article formed by welding together two or more welding base materials (e.g., the first base metal 11 and the second base metal 12 in this embodiment). That is to say, the first object 1 is a welded product.

Examples of the types of defects to be produced to a welded product include a pit, a sputter, a projection, a burn-through, and an undercut. The extracted part 140 covers at least a part of the defect produced spot E1 where at least one defect selected from the group consisting of a pit, a sputter, a projection, a burn-through, and an undercut has been produced to the welded product. In this embodiment, the extracted part 140 covers the entire defect produced spot E1 and the defect is an undercut. The grayscale of the extracted part 140 corresponds to the depth of the undercut.

As used herein, the “pit” refers to a depression produced to the bead 13. The “sputter” as used herein refers to a spherical or truncated cone shaped projection produced to the bead 13. The “projection” as used herein refers to a circular columnar projection produced to the bead 13. The “burn-through” as used herein refers to a missing part, which has been melted down, of the bead 13. The “undercut” as used herein refers to a depression produced around the bead 13.

The extracted part 140 does not have to be the defective part 14 but may also be a part with no defects. Alternatively, the extracted part 140 may include the defective part 14 and a part around the defective part 14. Still alternatively, the extracted part 140 may include a plurality of defective parts 14.

In particular, if the defect produced to the first object 1 is a defect produced in a narrow range (such as a pit, a sputter, or a projection), the extracted part 140 preferably covers not only a single defective part 14 but also a part around the defective part 14 or another defective part 14. This ensures a sufficient length for the extracted part 140, thus making the processing of bending the extracted part 140 and the processing of dividing the extracted part 140 more significant processing.

### (9) Machine Learning and Go/No-Go Decision

The image outputter 59 outputs the superposed image P4 generated by the image processor 53 to the learner 60. The learner 60 makes machine learning using the superposed image P4 as learning data (or learning dataset). In this manner, the learner 60 generates the learned model 82. As described above, the learner 60 may use not only the superposed image P4 but also the first image P1 and the second image P2 as the learning data.

The learning dataset is generated by attaching not only a label “non-defective” or “defective” to each of a plurality of image data items but also a label indicating the type and location of the defect to each of a plurality of image data items in the case of a defective product. The operation of attaching the label may be performed by, for example, the user via the user interface 55. Alternatively, the operation of attaching the label may also be performed by the setting information generator 56. The learner 60 generates a learned model 82 by machine-learning the conditions (namely, a non-defective condition, a defective condition, the type of the defect, and the location of the defect) of the object.

Optionally, the learner 60 may attempt to improve the performance of the learned model 82 by making re-learning using a learning dataset including newly acquired learning data. For example, if a new type of defect has been detected in the object, then the learner 60 may be made to make re-learning about the new type of defect.

On a production line at a factory, for example, the image capture device shoots an object to generate an inspection image P5. More specifically, the image capture device shoots an object on which a bead has been formed by actually going through a welding process, thereby generating the inspection image P5. The inspection image acquirer 62 acquires the inspection image P5 from the image capture device. The decider 61 makes, using the learned model 82 generated by the learner 60, a go/no-go decision of the inspection image P5 (object) acquired by the inspection image acquirer 62. In addition, if the object is a defective product, the decider 61 also determines what type of defect has been detected and where the defect is located. The decider 61 outputs the decision result 83. The decision result 83 may be output to the display device 58, for example. In response, the display device 58 displays the decision result 83. This allows the user to check the decision result 83 on the display device 58. Alternatively, the manufacturing equipment may also be controlled such that an object recognized as a defective product by the decider 61 is discarded before being passed to the next processing step. The decision result 83 may be output to, and stored in, a data server, for example.

As described above, the image generation system 5 includes the inspection image acquirer 62 for acquiring the inspection image P5 and the decider 61 for making a go/no-go decision of the inspection image P5 using the learned model 82. The learned model 82 is generated based on the superposed image P4 generated by the image processor 53.

### (10) Flow of Operation

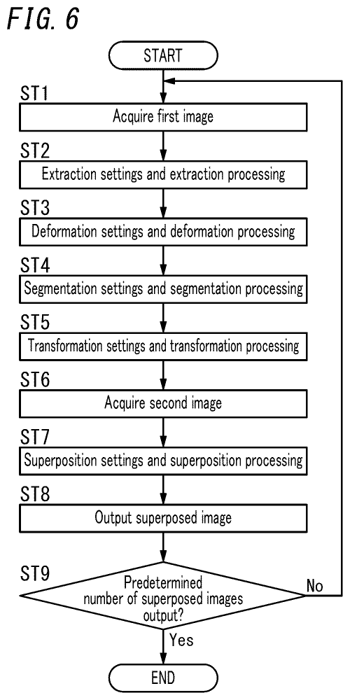

Next, the flow of the processing that allows the image generation system 5 to generate the superposed image P4 will be described with reference to FIG. 6. Note that the flow shown in FIG. 6 is only an example and should not be construed as limiting. Optionally, the processing steps shown in FIG. 6 may be performed in a different order from the illustrated one, some of the processing steps shown in FIG. 6 may be omitted as appropriate, and/or an additional processing step may be performed as needed.

The setting information 81 acquired in Steps ST2-ST5 and ST7 may be either entered by the user via the user interface 55 or generated by the setting information generator 56. Alternatively, some pieces of the setting information 81 may be entered by the user via the user interface 55 and other pieces of the setting information 81 may be generated by the setting information generator 56.

First, the first image acquirer 51 acquires the first image P1 (in Step ST1). Next, the image processor 53 acquires setting information 81 about extraction settings and performs the extraction processing 71 based on the extraction settings (in Step ST2). In this manner, an extracted image is generated (refer to FIG. 4A). As used herein, the setting information 81 about the extraction settings refers to a piece of information for use to define the range of the extracted part 140 in the first image P1.

Next, the image processor 53 acquires the setting information 81 about deformation settings and performs the deformation processing based on the deformation settings (in Step ST3). In this manner, a deformed image is generated (refer to FIG. 4B). As used herein, the setting information 81 about the deformation settings refers to a piece of information to be referred to in order to deform the extracted part 140 by bending the extracted part 140 and may include, for example, information indicating the point of bending and the angle of bending.

Subsequently, the image processor 53 acquires the setting information 81 about segmentation settings and performs the segmentation processing based on the segmentation settings (in Step ST4). As used herein, the setting information 81 about the segmentation settings includes a piece of information for use to determine the number of segments of the extracted part 140, for example.

Next, the image processor 53 acquires the setting information 81 about transformation settings and performs the transformation processing based on the transformation settings (in Step ST5). As used herein, the setting information 81 about the transformation settings refers to a piece of information for use to enter a change in at least one parameter selected from the group consisting of a grayscale of the extracted part 140, the location of the extracted part 140, the size of the extracted part 140, and an orientation of the extracted part 140. The transformation processing is the processing of changing at least one parameter selected from the group consisting of the grayscale of the extracted part 140, the location of the extracted part 140, the size of the extracted part 140, and the orientation of the extracted part 140. Optionally, the transformation processing allows the grayscale, location, size, and orientation (rotational angle) to be changed on a segment 141 basis.

Next, the second image acquirer 52 acquires the second image P2 (in Step ST6). In addition, the image processor 53 acquires the setting information 81 about superposition settings and performs the superposition processing based on the superposition settings (in Step ST7). The setting information 81 about the superposition settings includes, for example, a piece of information for use to determine the mixing ratio of the transformed image P3 and the second image P2 in the superposition processing 74.

Thereafter, the image processor 53 outputs the superposed image P4 generated by the superposition processing 74 (in Step ST8).

The image processor 53 determines whether a predetermined number (or more than the predetermined number) of superposed images P4 have been output (in Step ST9). If the predetermined number of superposed images P4 have already been output, the image processor 53 ends the processing of generating the superposed images P4. On the other hand, if the predetermined number of superposed images P4 have not been output yet, the process returns to the processing step ST1. The predetermined number of superposed images P4 are generated by repeatedly performing the series of processing steps ST1-ST8.

The minimum required number of the first image P1 is one and the minimum required number of the second image P2 is also one. When one superposed image P4 is generated and when another superposed image P4 is generated, at least one of the first image P1 or the second image P2 may be changed.

Optionally, one superposed image P4 generated by the image processor 53 may be used as either the first image P1 or the second image P2 when another superposed image P4 is generated.

### (11) Advantages

The image generation system 5 according to this embodiment may generate a superposed image P4 suitable for machine learning. In particular, the image generation system 5 deforms the extracted part 140 according to the shape of the second object 2 shot in the second image P2, thus making the superposed image P4 a more natural image than in a situation where an image representing the extracted part 140 is superposed on the second image P2 with no such deformation made. That is to say, this allows the superposed image P4 to reproduce a defect that would actually be produced to the second object 2. This makes the learned model 82 generated by using the superposed image P4 such a model that allows the user to accurately determine whether or not there is any defect and detect the type of the defect if any.

In addition, the image representing the extracted part 140 is subjected to image processing on a segment 141 basis. This enables more easily determining a parameter (i.e., the setting information 81) that determines the processing of subjecting the image representing the extracted part 140 to image processing than in a situation where the extracted part 140 is not divided, thus making it easier to generate a superposed image P4 desirable for the user, for example. This contributes to improving the accuracy of machine learning using the superposed image P4.

### First Variation

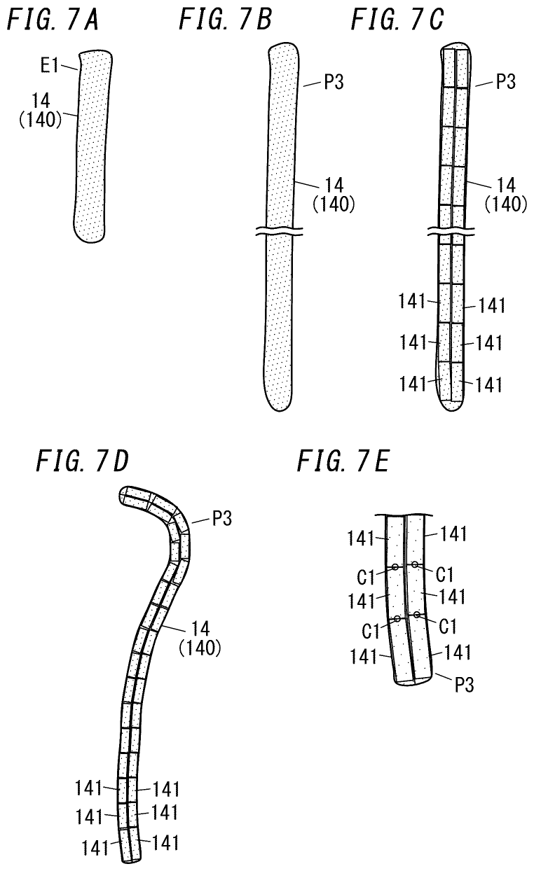

Next, a first variation will be described with reference to FIGS. 7A-7E. The image generation system 5 according to this first variation has the same configuration as its counterpart according to the exemplary embodiment described above. Thus, any constituent element of this first variation, having the same function as a counterpart of the exemplary embodiment described above, will be designated by the same reference numeral as that counterpart's, and description thereof will be omitted herein.

The setting information 81 for use in the processing of generating the superposed image P4 based on the first image P1 and the second image P2 may be either entered by the user via the user interface 55 or generated by the setting information generator 56 as in the exemplary embodiment described above. Alternatively, some pieces of the setting information 81 may be entered by the user via the user interface 55 and other pieces of the setting information 81 may be generated by the setting information generator 56.

In this first variation, after having performed the segmentation processing of dividing the extracted part 140 into a plurality of segments 141, the image processor 53 performs the processing of deforming the extracted part 140 according to the shape of the second object 2 shot in the second image P2.

First, as in the exemplary embodiment described above, the image processor 53 performs the processing of extracting the extracted part 140 from the first object 1 shot in the first image P1 (refer to FIG. 2). As a result, an extracted image is generated by extracting the extracted part 140 as shown in FIG. 7A. Optionally, the image processor 53 may perform the processing of flipping (mirror-reversing) the extracted part 140 as appropriate.

Next, the image processor 53 performs the processing of expanding or compressing the extracted part 140 in a predetermined direction. As a result, a transformed image P3 is generated as shown in FIG. 7B. The expansion and compression processing may be omitted as appropriate.

Subsequently, the image processor 53 performs the segmentation processing. As a result, a transformed image P3 is generated as shown in FIG. 7C.

The image processor 53 further subjects the image of the extracted part 140 to image processing on a segment 141 basis. The image processor 53 performs at least the processing of deforming the extracted part 140 according to the shape of the second object 2 shot in the second image P2 (hereinafter referred to as “bending processing”).

The center of rotation C1 of each of the plurality of segments 141 is arranged to be adjacent to another segment 141 (refer to FIG. 7E). The bending processing includes deforming the extracted part 140 by rotating at least some segment 141 around the center of rotation C1 thereof. As a result of the bending processing, a transformed image P3 is generated as shown in FIG. 7D.

Optionally, the bending processing may include the processing of correcting the transformed image P3 after having rotated at least some segment 141. For example, the transformed image P3 may be corrected to smoothly connect together the plurality of segments 141.

The image processor 53 further performs transformation processing (processing 73) on at least some segment 141. The transformation processing is the processing of changing at least one parameter selected from the group consisting of a grayscale of the extracted part 140, the location of the extracted part 140, the size of the extracted part 140, and an orientation of the extracted part 140. In this case, the transformation processing allows the grayscale, location, size, and orientation to be changed on a segment 141 basis.

After having performed the transformation processing, the image processor 53 superposes the transformed image P3 on the second image P2, thereby generating a superposed image P4 as shown in FIG. 5.

As described above, according to this variation, the extracted part 140 is divided into a plurality of segments 141 and at least some segment 141 is rotated, thereby having the bending processing done. This allows, even if the user determines and enters the setting information 81 about the bending processing, the setting information 81 to be determined easily by reducing the amount of information required to determine the setting information 81.

### Other Variations of Exemplary Embodiment

Next, other variations of the exemplary embodiment will be enumerated one after another. Note that the variations to be described below may be adopted in combination as appropriate. Alternatively, the variations to be described below may also be adopted in combination with the first variation described above.

The learned model 82 does not have to be a model for use in the weld appearance test but may also be a model for use in any of various other types of inspection. In addition, the learned model 82 does not have to be a model used for inspection purposes but may also be a model for use in various types of image recognition.

The agent that performs the extraction processing 71 does not have to be the image processor 53 but may also be provided outside of the image generation system 5.

At least one of the user interface 55, the display device 58, the learner 60, or the decider 61 may be provided outside of the image generation system 5.

The display device 58 may be a mobile communications device such as a smartphone or a tablet computer.

The images processed by the image generation system 5 (including the first image P1, the second image P2, the transformed image P3, the superposed image P4, and the inspection image P5) do not have to be three-dimensional images but may also be two-dimensional images or even four-or more-dimensional images.

The superposed image P4 generated based on the first image P1 and the second image P2 does not have to be a defective product image but may also be a non-defective product image.

The first object 1 shot in the first image P1 may be an article having either the same shape as, or a different shape from, the second object 2 shot in the second image P2.

The first image P1 and the second image P2 may be the same image.

The first image P1 and the second image P2 may be defective product images or non-defective product images, whichever is appropriate. Alternatively, one of the first and second images P1, P2 may be a non-defective product image and the other may be a defective product image.

The first image P1 may be an image generated by shooting only a part of the first object 1. The second image P2 may be an image generated by shooting only a part of the second object 2.

The image processor 53 may extract a plurality of extracted parts 140. In that case, a plurality of transformed images P3 are generated.

The image processor 53 may generate a plurality of transformed images P3 from a single extracted part 140.

The superposition processing 74 may include making the image processor 53 superpose a plurality of transformed images P3 on the second image P2.

In the transformed image P3, the plurality of segments 141 do not have to be connected together. Alternatively, some segments 141 may be provided separately from the other segments 141.

The center of rotation C1 of a segment 141 may be provided at a location distant from the segment 141.

The first image P1, the second image P2, the transformed image P3, the superposed image P4, and the inspection image P5 may be luminance image data representing the luminance of an object by grayscales.

In the exemplary embodiment described above, the “grayscales” represent densities of a single color (e.g., the color black). Alternatively, the “grayscales” may also represent respective densities of multiple different colors (such as the three colors of RGB).

A range in which the transformed image P3 is placed on the second image P2 may be defined by the user by operating the user interface 55. For example, the range in which the transformed image P3 is placed on the second image P2 may be selected from the group consisting of the first base metal 21, the second base metal 22, and the bead 23. If the first base metal 21 has been selected as the range in which the transformed image P3 is placed on the second image P2, then the image processor 53 may dispose the transformed image P3 at a randomly selected location on the first base metal 21.

The image generation system 5 according to the present disclosure or the agent that performs the image generation method according to the present disclosure includes a computer system. The computer system may include a processor and a memory as principal hardware components thereof. The computer system performs at least some functions of the image generation system 5 according to the present disclosure or serves as the agent that performs the image generation method according to the present disclosure by making the processor execute a program stored in the memory of the computer system. The program may be stored in advance in the memory of the computer system. Alternatively, the program may also be downloaded through a telecommunications line or be distributed after having been recorded in some non-transitory storage medium such as a memory card, an optical disc, or a hard disk drive, any of which is readable for the computer system. The processor of the computer system may be made up of a single or a plurality of electronic circuits including a semiconductor integrated circuit (IC) or a large-scale integrated circuit (LSI). As used herein, the “integrated circuit” such as an IC or an LSI is called by a different name depending on the degree of integration thereof. Examples of the integrated circuits such as an IC or an LSI include integrated circuits called a “system LSI,” a “very-large-scale integrated circuit (VLSI),” and an “ultra-large-scale integrated circuit (ULSI).” Optionally, a field-programmable gate array (FPGA) to be programmed after an LSI has been fabricated or a reconfigurable logic device allowing the connections or circuit sections inside of an LSI to be reconfigured may also be adopted as the processor. Those electronic circuits may be either integrated together on a single chip or distributed on multiple chips, whichever is appropriate. Those multiple chips may be aggregated together in a single device or distributed in multiple devices without limitation. As used herein, the “computer system” includes a microcontroller including one or more processors and one or more memories. Thus, the microcontroller may also be implemented as a single or a plurality of electronic circuits including a semiconductor integrated circuit or a large-scale integrated circuit.

Also, in the embodiment described above, the plurality of functions of the image generation system 5 are integrated together in a single device. However, this is not an essential configuration for the image generation system 5. Alternatively, those constituent elements of the image generation system 5 may be distributed in multiple different devices. Still alternatively, at least some functions of the image generation system 5 (e.g., at least some functions of at least one of the image processor 53, the learner 60, or the decider 61) may be implemented as either a server or a cloud computing system as well. Conversely, the plurality of functions of the image generation system 5 may be integrated together in a single device.

### Recapitulation

The exemplary embodiment and its variations described above are specific implementations of the following aspects of the present disclosure.

An image generation system (5) according to a first aspect includes a first image acquirer (51), a second image acquirer (52), and an image processor (53). The first image acquirer (51) acquires a first image (P1) by shooting a first object (1). The second image acquirer (52) acquires a second image (P2) by shooting a second object (2). The image processor (53) performs image transformation processing and superposition processing (74). The image transformation processing includes generating, based on the first image (P1), a transformed image (P3) by subjecting an extracted part (140) that forms a predetermined part of the first object (1) to image processing. The superposition processing (74) includes generating a superposed image (P4) by superposing the transformed image (P3) on the second image (P2). The image transformation processing includes: processing of dividing the extracted part (140) into a plurality of segments (141); and processing of changing at least one parameter selected from the group consisting of a grayscale, a location, a size, and an orientation of at least one segment (141) belonging to the plurality of segments (141).

This configuration enables generating an image (superposed image (P4)) suitable for machine learning. In particular, before a superposed image (P4) is generated by superposing the transformed image (P3) on the second image (P2), the processing of dividing the extracted part (140) into a plurality of segments (141) is performed, and the processing (transformation processing) of changing at least one parameter selected from the group consisting of a grayscale, a location, a size, and an orientation of at least one segment (141) is further performed. That is to say, the transformation processing is performed on a segment (141) basis. This makes it easier to determine the parameter (setting information (81)) as a decisive factor of the transformation processing and generate a superposed image (P4) desired for the user, for example, compared to a situation where the extracted part (140) is not divided. This contributes to improving the accuracy of machine learning using the superposed image (P4).

An image generation system (5) according to a second aspect, which may be implemented in conjunction with the first aspect, further includes a setting information inputter (54). The setting information inputter (54) acquires setting information (81) about processing of generating the superposed image (P4) based on the first image (P1) and the second image (P2). The setting information inputter (54) acquires the setting information (81) from a user interface (55) that accepts an operation performed by a user to enter the setting information (81).

This configuration allows the user to specify the setting information (81).

An image generation system (5) according to a third aspect, which may be implemented in conjunction with the first or second aspect, further includes a setting information generator (56).

The setting information generator (56) generates setting information (81) about processing of generating the superposed image (P4) based on the first image (P1) and the second image (P2).

This configuration enables generating the setting information (81) even without making the user specify the setting information (81).

In an image generation system (5) according to a fourth aspect, which may be implemented in conjunction with the second or third aspect, the setting information (81) includes one or more pieces of information selected from the following first to fourth pieces of information. A first piece of information which may be included in the setting information (81) is information for use to define a range of the extracted part (140) in the first image (P1). A second piece of information which may be included in the setting information (81) is information for use to determine the number of segments of the extracted part (140) in the image transformation processing. A third piece of information which may be included in the setting information (81) is information for use to change at least one parameter selected from the group consisting of a grayscale, a location, a size, and an orientation of the at least one segment (141) in the image transformation processing. A fourth piece of information which may be included in the setting information (81) is information for use to determine a mixing ratio of the transformed image (P3) and the second image (P2) in the superposition processing (74).

This configuration allows the transformed image (P3) to be generated according to the contents of the setting information (81).

In an image generation system (5) according to a fifth aspect, which may be implemented in conjunction with any one of the first to fourth aspects, the first image (P1) is an image generated by shooting a defect produced spot (E1) of the first object (1). The second image (P2) is an image generated by shooting the second object (2) as a non-defective product. The extracted part (140) includes at least a part of the defect produced spot (E1).

This configuration allows a defective product image to be generated as the superposed image (P4).

In an image generation system (5) according to a sixth aspect, which may be implemented in conjunction with the fifth aspect, the first object (1) is a welded product. The extracted part (140) includes at least a part of a defect produced spot (E1) that takes the form of at least one selected from the group consisting of a pit, a sputter, a projection, a burn-through, and an undercut, all of which may be present in the welded product.

This configuration allows a defective product image of the welded product to be generated as the superposed image (P4).

An image generation system (5) according to a seventh aspect, which may be implemented in conjunction with any one of the first to sixth aspects, further includes an image outputter (59). The image outputter (59) outputs the superposed image (P4), generated by the image processor (53), to a learner (60). The learner (60) performs machine learning using the superposed image (P4) as learning data.

This configuration allows a high-accuracy learned model (82) to be generated by machine learning based on the superposed image (P4).

An image generation system (5) according to an eighth aspect, which may be implemented in conjunction with any one of the first to seventh aspects, further includes an inspection image acquirer (62) and a decider (61). The inspection image acquirer (62) acquires an inspection image (P5). The decider (61) makes a go/no-go decision of the inspection image (P5) using a learned model (82). The learned model (82) is generated based on the superposed image (P4) that has been generated by the image processor (53).

This configuration allows the go/no-go decision to be made with high accuracy by using a learned model (82) which has been generated based on the superposed image (P4).

In an image generation system (5) according to a ninth aspect, which may be implemented in conjunction with any one of the first to eighth aspects, the superposed image (P4) is a three-dimensional image in which depth is expressed as grayscales.

This configuration allows machine learning to be made with depth information taken into account.

An image generation system (5) according to a tenth aspect, which may be implemented in conjunction with any one of the first to ninth aspects, further includes a display outputter (57). The display outputter (57) outputs information about the plurality of segments (141) to a display device (58). The display device (58) displays the plurality of segments (141) in accordance with information, acquired from the display outputter (57), about the plurality of segments (141).

This configuration allows the user to recognize the plurality of segments (141).

In an image generation system (5) according to an eleventh aspect, which may be implemented in conjunction with any one of the first to tenth aspects, the image transformation processing includes making each of the plurality of segments (141) rotatable with respect to at least another one of the plurality of segments (141).

This configuration allows an image representing the extracted part (140) to be bent by rotating the segment (141).

In an image generation system (5) according to a twelfth aspect, which may be implemented in conjunction with the eleventh aspect, the image transformation processing includes setting a center of rotation (C1) of each of the plurality of segments (141) adjacent to the at least another one of the plurality of segments (141).

This configuration allows segments (141) to be deformed rotationally with two adjacent segments (141) kept connected to each other.

Note that the constituent elements according to the second to twelfth aspects are not essential constituent elements for the image generation system (5) but may be omitted as appropriate.

An image generation method according to a thirteenth aspect includes first image acquisition processing, second image acquisition processing, image transformation processing, and superposition processing (74). The first image acquisition processing includes acquiring a first image (P1) by shooting a first object (1). The second image acquisition processing includes acquiring a second image (P2) by shooting a second object (2). The image transformation processing includes generating, based on the first image (P1), a transformed image (P3) by subjecting an extracted part (140) that forms a predetermined part of the first object (1) to image processing. The superposition processing (74) includes generating a superposed image (P4) by superposing the transformed image (P3) on the second image (P2). The image transformation processing includes: processing of dividing the extracted part (140) into a plurality of segments (141); and processing of changing at least one parameter selected from the group consisting of a grayscale, a location, a size, and an orientation of at least one segment (141) belonging to the plurality of segments (141).

This method enables generating an image (i.e., the superposed image (P4)) suitable for machine learning.

An image generation method according to a fourteenth aspect, which may be implemented in conjunction with the thirteenth aspect, further includes setting information generation processing including generating setting information (81) about processing of generating the superposed image (P4) based on the first image (P1) and the second image (P2).

This method enables generating the setting information (81) even without making the user specify the setting information (81).

Note that the features according to the fourteenth aspect are not essential features for the image generation method but may be omitted as appropriate.

A program according to a fifteenth aspect is designed to cause one or more processors of a computer system to perform the image generation method according to the thirteenth or fourteenth aspect.

This program enables generating an image (i.e., the superposed image (P4)) suitable for machine learning.

Note that these are not the only aspects of the present disclosure but various configurations (including variations) of the image generation system (5) according to the exemplary embodiment described above may also be implemented as, for example, an image generation method, a (computer) program, or a non-transitory storage medium on which the program is stored.

### REFERENCE SIGNS LIST

1 First Object
2 Second Object
5 Image Generation System
51 First Image Acquirer
52 Second Image Acquirer
53 Image Processor
54 Setting Information Inputter
55 User Interface
56 Setting Information Generator
57 Display Outputter
58 Display Device
59 Image Outputter
60 Learner
61 Decider
62 Inspection Image Acquirer
74 Superposition Processing
81 Setting Information
82 Learned Model
140 Extracted Part
141 Segment
C1 Center of Rotation
E1 Defect Produced Spot
P1 First Image
P2 Second Image
P3 Transformed Image
P4 Superposed Image
P5 Inspection Image

1. An image generation system comprising:
a first image acquirer configured to acquire a first image by shooting a first object;
a second image acquirer configured to acquire a second image by shooting a second object; and
an image processor configured to perform image transformation processing and superposition processing, the image transformation processing including generating, based on the first image, a transformed image by subjecting an extracted part to image processing, the extracted part forming a predetermined part of the first object, the superposition processing including generating a superposed image by superposing the transformed image on the second image,
the image transformation processing including:
processing of dividing the extracted part into a plurality of segments; and
processing of changing at least one parameter selected from the group consisting of a grayscale, a location, a size, and an orientation of at least one segment belonging to the plurality of segments.

2. The image generation system of claim 1, further comprising a setting information inputter configured to acquire setting information about processing of generating the superposed image based on the first image and the second image, wherein
the setting information inputter is configured to acquire the setting information from a user interface configured to accept an operation performed by a user to enter the setting information.

3. The image generation system of claim 1, further comprising a setting information generator configured to generate setting information about processing of generating the superposed image based on the first image and the second image.

4. The image generation system of claim 2, wherein
the setting information includes one or more pieces of information selected from the group consisting of:
information for use to define a range of the extracted part in the first image;
information for use to determine a numerical number of segments of the extracted part in the image transformation processing;
information for use to enter a change in at least one parameter selected from the group consisting of a grayscale, a location, a size, and an orientation of the at least one segment in the image transformation processing; and
information for use to determine a mixing ratio of the transformed image and the second image in the superposition processing.

5. The image generation system of claim 1, wherein
the first image is an image generated by shooting a defect produced spot of the first object,
the second image is an image generated by shooting the second object as a non-defective product, and
the extracted part includes at least a part of the defect produced spot.

6. The image generation system of claim 5, wherein
the first object is a welded product, and
the extracted part includes at least a part of a defect produced spot that takes a form of at least one selected from the group consisting of a pit, a sputter, a projection, a burn-through, and an undercut which are to be present in the welded product.

7. The image generation system of claim 1, further comprising an image outputter configured to output the superposed image, generated by the image processor, to a learner configured to perform machine learning using the superposed image as learning data.

8. The image generation system of claim 1, further comprising:
an inspection image acquirer configured to acquire an inspection image; and
a decider configured to make a go/no-go decision of the inspection image using a learned model, the learned model being generated based on the superposed image that has been generated by the image processor.

9. The image generation system of claim 1, wherein
the superposed image is a three-dimensional image in which depth is expressed as grayscales.

10. The image generation system of claim 1, further comprising a display outputter configured to output information about the plurality of segments to a display device, wherein
the display device is configured to display the plurality of segments in accordance with information, acquired from the display outputter, about the plurality of segments.

11. The image generation system of claim 1, wherein
the image transformation processing includes making each of the plurality of segments rotatable with respect to at least another one of the plurality of segments.

12. The image generation system of claim 11, wherein
the image transformation processing includes setting a center of rotation of each of the plurality of segments adjacent to the at least another one of the plurality of segments.

13. An image generation method comprising:
first image acquisition processing including acquiring a first image by shooting a first object;
second image acquisition processing including acquiring a second image by shooting a second object;
image transformation processing including generating, based on the first image, a transformed image by subjecting an extracted part to image processing, the extracted part forming a predetermined part of the first object; and
superposition processing including generating a superposed image by superposing the transformed image on the second image,
the image transformation processing including:
processing of dividing the extracted part into a plurality of segments; and
processing of changing at least one parameter selected from the group consisting of a grayscale, a location, a size, and an orientation of at least one segment belonging to the plurality of segments.

14. The image generation method of claim 13, further comprising setting information generation processing including generating setting information about processing of generating the superposed image based on the first image and the second image.

15. A non-transitory computer-readable storage medium storing a computer program designed to cause one or more processors of a computer system to perform the image generation method of claim 13.
